(19) United States
(12) Patent Application Publication
(10) Pub. No.: US 2024/0054704 A1
(43) Pub. Date: Feb. 15, 2024

(54) METHODS OF IMAGE MANIPULATION FOR CLOTHING VISUALISATION

(71) Applicant: ANTHROPICS TECHNOLOGY LIMITED, London (GB)

(72) Inventors: Tony Polichroniadis, London (GB); Ivor Simpson, London (GB)

(21) Appl. No.: 17/768,442

(22) PCT Filed: Oct. 15, 2020
(86) PCT No.: PCT/GB2020/052599

§ 371 Date: Apr. 12, 2022

(30) Foreign Application Priority Data
Oct. 15, 2019 (GB) 1914924.4

(51) Int. Cl. G06T 11/60; G06T 3/00; G06T 7/50; G06T 7/73; G06T 7/13; G06T 7/11; G06Q 30/0601

(52) U.S. Cl. CPC G06T 11/60; G06T 3/0093; G06T 7/50; G06T 7/73; G06T 7/13; G06T 7/11; G06Q 30/0643; G06T 2210/16; G06T 2207/20081; G06T 2207/20092; G06T 2207/20132

(57) ABSTRACT

A method for transforming a clothing model image is disclosed. The method receives the clothing model image showing a first person wearing an item of clothing, the first person having a first body shape. The method receives a body shape model for a second person, the second data from a user person having a second body shape. The method determines a warp field for warping the first body shape in the clothing model image to the second body shape. The warp field is determined based on target curves determined from the body shape model for the second person. The method transforms the clothing model image in accordance with the warp field to generate a user warped clothing model image representing the second person wearing the item of clothing A method for determining a body shape model for a person is also disclosed.

This disclosure relates to methods of digitally manipulating an image, and in particular to methods of transforming an image for clothing visualisation. Methods disclosed herein concern manipulating an image of a person wearing clothing to show how the clothing may appear on another person.

### BACKGROUND

The clothing industry uses images of clothing models wearing items of clothing for the marketing and sale of clothing to consumers. Such images give consumers a visual impression of how the modelled clothing appears on a particular clothing model. However, consumers have to imagine how they might look wearing the same clothing. This may be difficult for consumers. For example, a consumer may be a different height, have a different body shape and/or have a different skin tone from the clothing model shown in the image.

Traditionally, consumers seeking to purchase clothing are able to try on items of clothing in a changing room of a retail outlet. However, this is time consuming and requires the retail outlet to have samples of a large number of items of clothing in a range of clothing sizes. Furthermore, this approach is not possible for online clothing retailers. Thus, it is desirable to provide images that are more tailored to customers to assist them in visualising how they would appear when wearing particular items of clothing in a variety of clothing styles.

An approach to generating images for clothing visualisation, which may help a consumer to imagine how they would appear in particular clothing, is to build a three-dimensional (3D) body and clothing simulation for image rendering. This requires both the user's body and the clothing to be represented in 3D. Although techniques for building a 3D body model of a person are known, for instance using input measurements (e.g. manually acquired measurements or measurements derived from body scans) or video images associated with the person concerned. 3D clothing simulation is expensive and time-consuming, since every item of clothing must be individually modelled in 3D. The time and expense involved in capturing a 3D clothing model of every item of clothing may be cost prohibitive. Moreover, when rendering an image for clothing visualisation, the fit of the clothing on the user's body in a particular pose needs to be modelled using cloth simulation, in order to provide an accurate visual representation.

This means that, for good results, not only do the clothing shape (e.g. style, length, cut etc.) and visual appearance (e.g. colour, texture etc.) of the item of clothing need to be modelled, but also the fabric properties need to be modelled to give the correct visual appearance on the user's body in a particular pose. For example, the drape of an item of clothing made of a heavy material such as wool, may be very different from the drape of an item of clothing of the same style made of a lighter fabric such as cotton or silk. Thus, 3D clothing modelling and simulation is challenging. In consequence, images rendered from 3D simulations based on 3D body and clothing models often appear unrealistic to the user.

Another approach to clothing visualisation is to provide images of multiple different clothing models wearing the same clothing, and allow the consumer to select the image(s) showing a clothing model that is closest to their own height, body shape and/or skin tone etc. However, this approach is expensive and time consuming since it requires images of multiple clothing models in multiple items of clothing to be captured. In consequence, such an approach may also be cost prohibitive. Furthermore, the limited choice of clothing models appearing in the images leads to a less tailored solution for users.

The present disclosure seeks to provide improved methods for generating images for clothing visualisation, which mitigates at least some of the above problems.

### SUMMARY

Aspects of the present invention are defined in the accompanying claims.

According to an aspect, there is provided a computer-implemented method for transforming a first image, the first image showing a first person wearing an item of clothing, the first person having a first physical body shape. The method comprises receiving attribute data from a user indicative of the user's physical body shape. The method further comprises producing a body shape representation for the user based on the attribute data. The method comprises receiving the first image, and determining, based on the determined body shape representation, an image warp for warping the first image such that the first person is depicted as having the user's body shape. The method additionally comprises transforming the first image in accordance with the determined image warp to generate a warped first image representing the user wearing the item of clothing.

Optionally, the method may further comprise determining the pose of the first person in the first image; determining target curves based on the determined pose and based on the user's physical body shape representation, and determining the warp based on the determined target curves.

Optionally, determining the pose of the first person comprises representing the first physical body shape as an image body geometry, the image body geometry comprising a set of points and curves, wherein each point represents the position of a skeleton joint, and each curve represents the position and shape of a respective body part relative to a bone between two skeleton joints represented by a pair of the points. Optionally, each curve may be one of a pair of curves, and each pair of curves represents the position and shape of a respective body part relative to a bone between two skeleton joints represented by a pair of the points.

Optionally, determining the warp is further based on the curves of the image body geometry.

Optionally, the first image is divided into a plurality of sections, wherein a first section of the plurality of sections is associated with a first layer of the first image and a second section of the plurality of sections is associated with a second layer of the first image, the second layer being different to the first layer.

Optionally, transforming the first image in accordance with the determined image warp comprises transforming at least one of the plurality of sections.

Optionally, transforming at least one of the plurality of sections comprises transforming the first section such that a portion of the second section that was visible in the first image is occluded in the warped image.

Optionally, the method may further comprise detecting and correcting pixel artefacts in the warped first image.

Optionally, the method may further comprise changing the skin tone of the person shown in the first image to match the skin tone of the user.

Optionally, the skin tone of the second person is determined from an image of the user, a skin tone selected by a user or a combination thereof.

Optionally, the method may further comprise manipulating the warped first image to reposition one or more clothing edges of the item of clothing for consistency with the physical body shape of the user.

Optionally, the method may further comprise replacing the head and/or face of the first person in the first image with the head and/or face of the user based on a head image of the user provided by a user.

Optionally, the method may further comprise receiving the head image of the user; determining feature points of the head of the user in the head image; determining feature points of the head of the first person in the first image or a head pose of the first person in the first image; estimating a transform for the head image to reposition the head to a plausible location in the clothing model image, and creating a transformed head image of the user based on the estimated transform, for compositing into the warped first image.

Optionally, the transform for the head image is determined using a mathematical/machine learning model of head positions, wherein the inputs to the model include: the feature points of the head of the user in the head image, and the feature points of the head of the first person in the first image.

Optionally, the mathematical/machine learning model is determined using a dataset of training images comprising a plurality of sets of training images, wherein each set of training images comprises a plurality of images of the head of the same person at different head positions relative to their shoulders.

Optionally, the shoulders are either held in a fixed position for each of the images or else the shoulders in each of the training images are aligned using a computer vision technique; and optionally wherein the training images of each set of training images are aligned and/or scaled.

Optionally, the attribute data comprises the user's height, and the transformed head image is scaled based on the height of the user and the first person.

Optionally, replacing the head of the first person in the first image with the head of the user comprises: removing the head of the first person from the first image, and compositing the head image of the user and the first image.

Optionally, replacing the head of the first person in the first image with the head of the user comprises: computing, using a trained AI system, a first coordinate system based on feature points of the head of the user in the head image; computing, using the trained AI system, a second coordinate system based on feature points of the head of the first person in the first image; determining a transform between the first and second coordinate systems; and using the transform to replace the head of the first person in the first image with the head of the user in the head image.

Optionally, the trained AI system is trained using a dataset of images, each image in the dataset comprising a head part and a non-head part, wherein for each image in the dataset, the trained AI system is trained to predict a coordinate system from feature points of the head part and a coordinate system from feature points of the non-head part such that the difference between the coordinate system predicted from the feature points of the head part and the coordinate system predicted from the feature points of the non-head part is minimised.

Optionally, the attribute data comprises measurements provided by a user.

Optionally, determining the body shape representation for the user comprises: receiving the user measurements, the measurements relating to defined features of the user's physical body shape; estimating a body shape representation for the user based on the user measurements using one or more of: a mapping of user measurements to a physical body shape; a mapping of user measurements to one or more training images depicting people having a known physical body shape, and a machine learning/mathematical model for predicting body shape.

Optionally, the method may further comprise providing an image representation of the estimated body shape representation to the user, and adjusting the body shape representation based on feedback from the user.

Optionally, the mapping and/or machine learning/mathematical model for estimating the body shape representation is determined from a dataset of training images of a people of a known body shape in a plurality of different body poses.

According to an aspect, a method is provided for determining a body shape representation for a user, comprising receiving measurements relating to the user's body shape from the user; estimating a body shape representation for the user based on the user measurements, using one or more of: a mapping of user measurements to a physical body shape; a mapping of user measurements to one or more training images having a known physical body shape, and a machine learning/mathematical model for predicting body shape. The method further comprises providing an image representation of the estimated body shape representation to the user, and adjusting the body shape representation based on feedback from the user.

According to an aspect, a method is provided of replacing the head and/or face of a first person in a first image with the head and/or face of a user (and/or second person) based on a head image of the user provided by a user. The method comprises receiving the head image of the user; determining feature points of the head of the user in the head image; determining feature points of the head of the first person in the first image or a head pose of the first person in the first image; estimating a transform for the head image to reposition the feature points to match the determined features points of the head of the first person or the head pose in the clothing model image, and creating a transformed head image of the user based on the estimated transform, for compositing into the first image.

Optionally, the transform for the head image is determined using a mathematical/machine learning model of head positions. The inputs to the model may include the feature points of the head of the user in the head image, and the feature points of the head of the first person in the first image. Advantageously, this gives a more realistic image of a user's head and/or face on the body of a second person.

According to another aspect, a computer readable medium comprising instructions that, when executed by a processor, cause the processor to perform a method as disclosed herein.

Further features and advantages of implementations of the present disclosure will be appreciated from the following detailed description and accompanying claims.

### FIGURES

FIG. 1 is a flowchart of a method for determining a body shape representation for a user, in accordance with the present disclosure;

FIG. 2a depicts an image body geometry for a model in accordance with the present disclosure;

FIG. 2 is a flowchart of a method for digitally manipulating a clothing model image according to a user's body shape representation, in accordance with the present disclosure;

FIG. 3 is a flowchart of a method for head placement and compositing on a clothing model image, in accordance with the present disclosure;

FIG. 4 is a flowchart of a method for adjusting the position of clothing edges on a clothing model image, in accordance with the present disclosure, and

FIG. 5 illustrates the manipulation of an image according to the flowchart depicted in FIG. 4.

### DETAILED DESCRIPTION

The present disclosure concerns a method for digitally manipulating an image of a person (herein “clothing model” or “first person”) wearing an item of clothing (herein “clothing model image”), to provide a realistic representation of another person (herein “user” or “second person”) wearing the same item of clothing. In particular, the method transforms (“warps”) the image so that the apparent body shape of the clothing model in the image is changed to closely match the body shape of the user. In consequence of the image transformation, the clothing model image is warped to represent the user wearing the item of clothing.

In some implementations, the method further digitally manipulates the image to closely match the clothing model and/or item of clothing shown in the image to other features of the user. For example, the method may transform the skin tone, hair style, face and/or head of the clothing model in the image, to match the user's skin tone, hair style, face and/or head.

Accordingly, the present disclosure proposes a different approach from known techniques. In particular, the proposed technique starts from an image of a clothing model wearing at least one item of clothing. The new approach transforms the image to provide an image depicting how the user might look wearing the clothing using a “body shape representation” for the user. In the present disclosure, the term “body shape” refers to the physical body shape and includes the size as well as the shape of the body, including height. The body shape representation is a mathematical abstraction of the physical body shape and is uniquely determined for the user as described herein. Thus, for a particular clothing model image, the new approach determines a specific image transformation for the user.

As the skilled person will appreciate, an image of any person wearing an item of clothing may be used as a clothing model image. Thus, references to a clothing model are merely used for ease of description. Whilst the described implementations relate to a user seeking to visualise themselves wearing an item of clothing worn by a clothing model in a clothing model image, the techniques disclosed herein are equally applicable a user seeking to visualise another person wearing the item of clothing (provided measurements and/or a body shape representation for that person is available to the user).

Mathematical Modelling for Body Shape

The present disclosure utilises mathematical modelling and machine learning to gain an understanding of differences in physical body shape, and the visual effect on the apparent body shape in different poses, in images. Such an understanding enables more accurate image transformation of different body shapes in a wide variety of different poses that may be present in clothing model images that may be used for clothing visualisation.

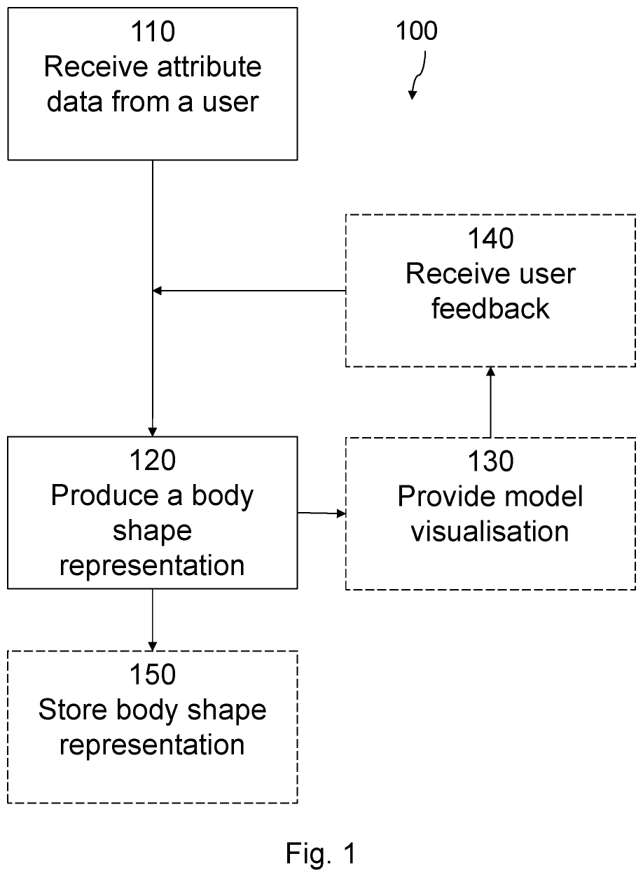

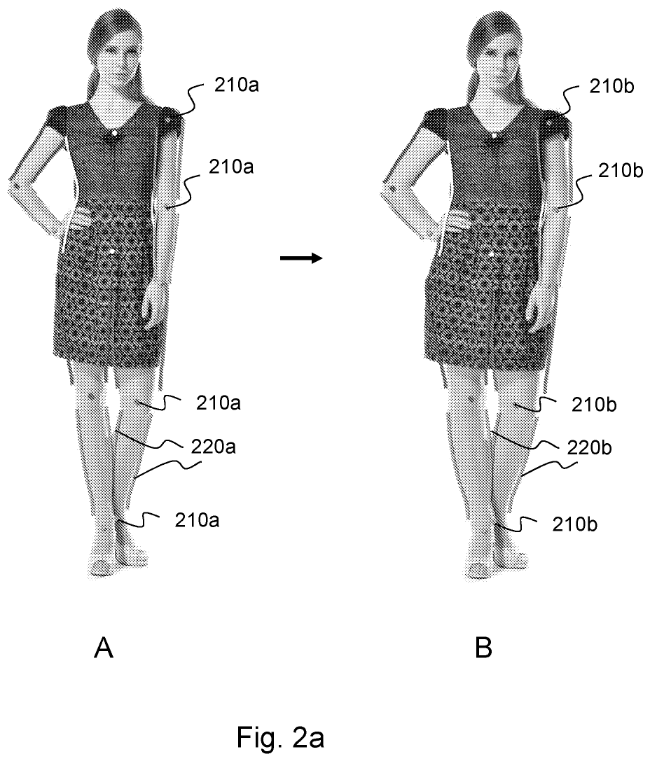

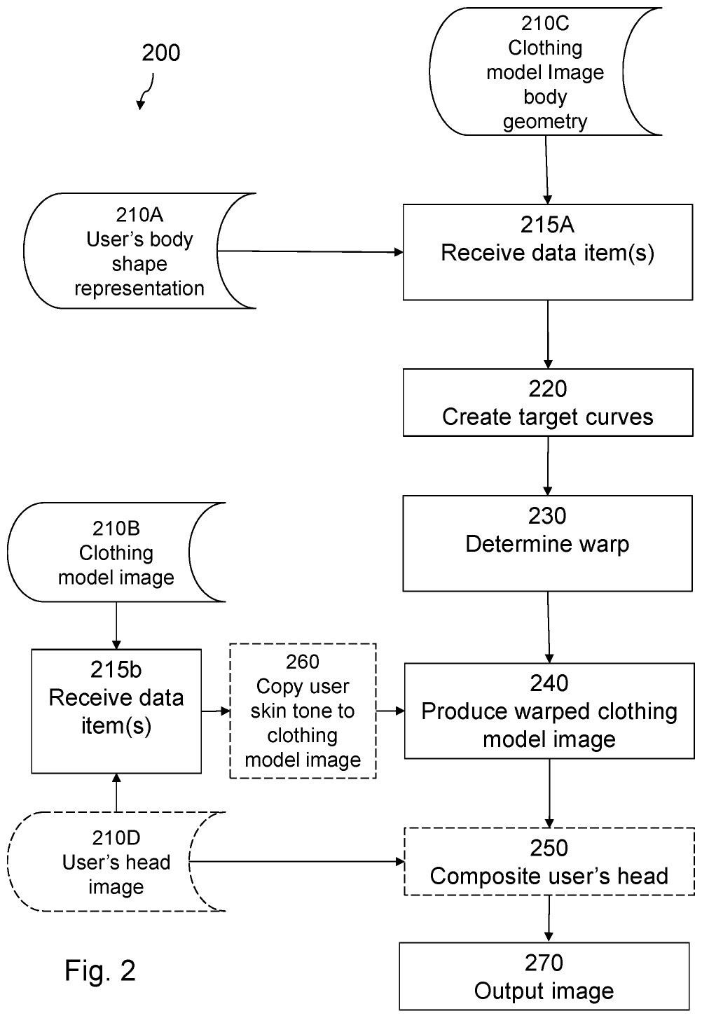

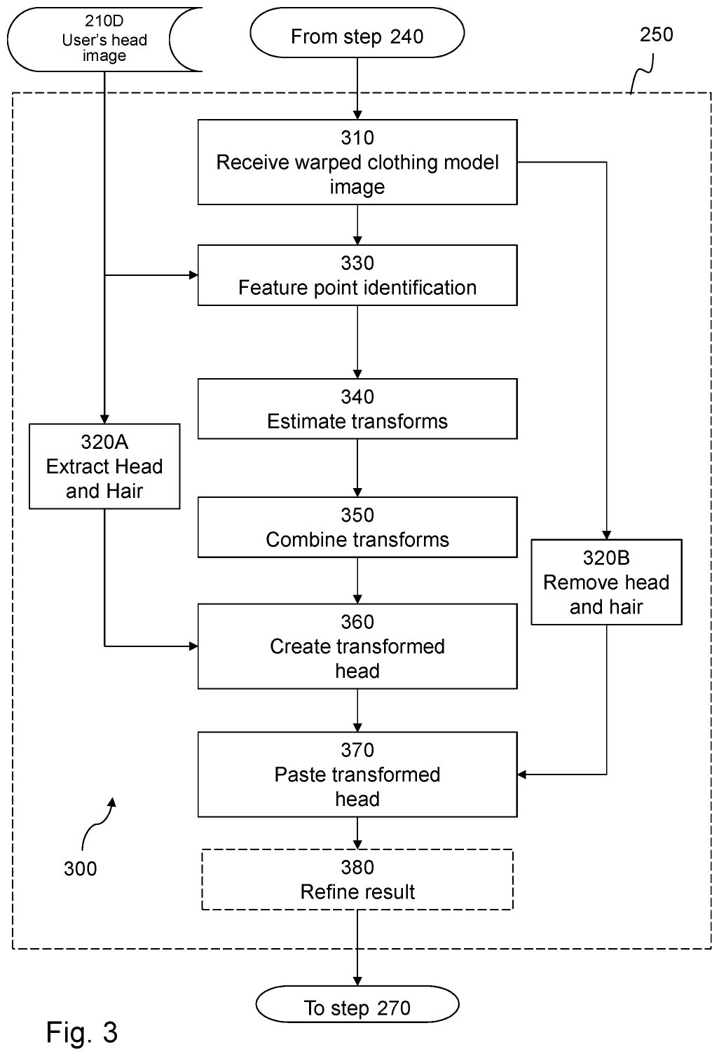

In accordance with the present disclosure, modelling enables estimation of a “body shape representation” of a person (e.g. user) based on a limited amount of input data relating to their body shape, which may be described as attribute data, optionally refined using feedback as described below with reference to FIG. 1. As indicated above, a body shape representation is a data representation comprising a mathematical abstraction (e.g. vector representation) of the physical body shape of a person. In addition, modelling enables an “image body geometry” to be determined to describe the apparent shape of a person in a particular pose in an image based on the body shape representation as described below with reference to FIGS. 2 and 3. An image body geometry is a mathematical data representation describing the apparent shape of a body in an image. An image body geometry is comprised of elements (specifically, skeleton joints, curves and occlusions) relating to the appearance of the body of a person in an image, most notably the body outline.

Modelling requires a training dataset containing a plurality of training subjects, with a collection of images (e.g. photographs) and a plurality of physical body measurements for each training subject. In particular, the training dataset comprises images of multiple subjects having different physical body shapes in different poses. For each training image, an image body geometry for the image (i.e. skeleton joints, curves and occlusions) is determined, as described in detail below. Thus, mathematical modelling and machine learning techniques are applied to define a body shape representation based on a mapping of how the physical body shape of each training subject appears in different poses in images.

Determining User Body Shape Representation

FIG. 1 is a flowchart showing a method 100 for producing, or determining, a body shape representation for a particular user, in accordance with implementations of the present disclosure. For example, a body shape representation may be determined when a user sets up an account for clothing visualisation with a particular vendor, retailer or the like, or otherwise according to application scenarios.

At block 110, attribute data is received from a user. The attribute data comprises data, and/or information, which describes one or more physical attributes of the user. The attribute data may comprise body measurements or indications of body size, for example at least one of height, chest, waist, hip and leg measurements, and other related data such as clothing size and so on.

In some implementations, the user is invited to enter user data comprising body measurements of the user. For example, the user may be invited to enter body measurement data into a graphical user interface indicating required and optional measurements for determining an estimate of the user's body shape representation. The required measurements may be the minimum number of measurements necessary for determining the body shape representation, such as height, clothing size and bra size (for women).

This attribute data may be input by the user via a number of on-screen sliders. A slider may comprise an on-screen element which the user can slide, via interaction with a GUI, between a maximum and a minimum value in order to select one of a range of values. For example, the user may be asked to enter their height or body/limb shape via such sliders. The same or similar input mechanisms can be used for providing feedback on the estimated shape representation.

At block 120, a body shape representation is produced. The body shape representation is produced based on the attribute data received from the user. In particular, the user attribute data received at block 110 may be input into a machine learning/mathematical model for producing a body shape representation for the user, or equivalent as described above. The producing may comprise estimating or predicting the body shape representation.

For example, the user attribute data may be matched to a known training subject, which has a known physical body shape represented by a set of known measurements that drives the matching process. Thus, in such an implementation, the body shape representation corresponds to the index of the closest matching training subject. In yet another implementation, the user data may be matched to a plurality of closest known training subjects where the body shape representation corresponds to a similarity weighting of the user to each of the training subjects. These examples can be extended to allow a body shape representation that contains a weighting for each training subject for specific body parts. In another implementation, a body shape representation could be defined by mathematical modelling and/or machine learning. In such an implementation, an abstract shape representation, consisting of a plurality of latent parameters, may be used to describe the shape of the person, rather than associating each user with individual training subjects. In such a scenario, a trained machine learning model would be used to predict the latent parameter values for the user's body shape representation based on the input measurements.

Optionally, the body shape representation may undergo user feedback in order to increase the perceived accuracy of the representation, and the final representation may be stored in memory.

Optionally, at block 130, a visualisation of the body shape representation is provided to the user. The provision is made via a screen or GUI of, for example, a mobile application. The visualisation is provided to the user for manual feedback. For example, one or more example output images from the currently estimated body shape representation may be displayed to the user on the graphical user interface, with one or more sliders or other user interactive tools that allows the user to make manual adjustments to the apparent body shape in the image. The graphical user interface may also allow the user to indicate that the estimated body shape representation shown in the displayed image is acceptable.

At block 140, feedback is received from the user. This is manual input provided by the user, indicating a required adjustment of the body shape representation. The user input may be in the form of the adjustment of one or more on-screen sliders, each of which relates to a specific aspect of physical body shape, such as hips size, stomach size, leg shape etc. Optionally, the user input may also include updated, or revised, attribute data. The feedback provided in block 140 is provided as manual feedback/additional user data to block 120. The feedback may necessitate a change or adjustment of the body shape representation produced at block 120. The adjustment may be a direct adjustment of the generated body shape representation, may be an adjustment of the attribute data used to generate the body shape representation, or a combination of both types of adjustments. The method may then repeat the process of providing an (updated/revised) body shape representation in block 120, providing a visualisation of body shape representation in block 130 and receiving manual feedback in block 140 until the user confirms that the estimated body shape model is acceptable.

Optionally, at block 150, the final body shape representation for the user is stored in data storage, in response to the user confirming that the estimated body shape representation is acceptable. It will be appreciated that the provision of user feedback in the manner described is optional.

As the skilled person will appreciate, the body shape representation determined for the user provides an abstraction of the physical body shape or description of the body shape of the user, which is independent of pose or body position. The body shape representation is specifically tailored to the individual user by enabling manual adjustments through visualisation by the user. The stored body shape representation for a user can be used to manipulate any clothing model image for clothing visualisation by the user, as described herein.

Image Body Geometry

Before describing the transformation of clothing model images for clothing visualisation in accordance with the present disclosure, it is useful to describe certain principles of transforming or “warping” body shapes within images. These principles are used in the digital manipulation of clothing model images based on the user's body shape representation as described above.

In implementations of the present disclosure, in order to warp the shape of a body in an image, the image body geometry must be identified and represented. This is achieved by identifying three elements that together represent the appearance of the body shape (e.g. body outline) in the pose shown in the image. Each element may comprise a set of one or more regions, region depth order, lines or points identified in an image. Occlusions can be described as a depth ordering from the camera, which can be represented via a binary relationship for each pair of limb as which is in front of the other.

FIG. 2A shows an example clothing model image of a clothing model in a pose, to illustrate the elements of the image body geometry used in accordance with the present disclosure. This is image ‘A’. FIG. 2A also shows the example clothing model image after warping according to a body shape representation of another person. This is image ‘B’.

Image B is a warped or transformed image which has been produced based on a user's body shape representation and based on image A.

In image A the model has a distinct pose, which can be represented or described using an ‘image body geometry’. Determining the pose of the model (or ‘first person’) in the image comprises representing the model's physical body shape as an image body geometry which comprises a set of points and curves. The curves may be referred to as splines, and may be defined by control points along the curve. An example of such points and curves is shown in FIG. 2A. Each point represents the position of a skeleton joint. Each curve is one of a pair of curves, and each pair of curves represents the position and shape of a respective body part relative to a bone between two skeleton joints represented by a pair of the points. For example, a pair of curves or curved lines 220a define the model's left lower leg. These curves define the outline of the lower leg as shown in the image. The relevant and associated ‘points’ are the model's left knee and her left ankle.

In an implementation, rather than each curve being part of a pair of curves, a body representation may consider each side of a sub-limb separately.

The first element comprises the locations of a predefined set of skeleton joints (e.g. shoulder, elbow, wrist, hip, knee, breastbone, sacrum etc.) of the body in the image. These locations may be described as nodes, points, or locations in the image. Not all of the skeleton joints may be identifiable in an image, for example if the image shows only the upper body then the lower body joints are not visible. Thus, a set of points representing the locations of predefined skeleton joints of the body are identified in the image. Image A of FIG. 2A shows a set of points corresponding to identified skeleton joints, which are shown by circles 210a in the image. As can be seen from appreciation of the corresponding set of points 210b of image B, the locations of the skeleton joints remain substantially the same in the image after warping.

The second element comprises the visible outline shape of the body parts with respect to the limb or sub-limb between specific pairs of identified skeleton joints. For example, a set of connections (lines) are made between specific pairs of points, each connection representing a bone between a pair of skeleton joints (e.g., upper arm bone between shoulder and elbow joints). The 2d shape of the body part in the image associated with each bone may be represented as a pair of curves either side of the connection representing the bone. Each curve comprises a continuous locus of points defined by a one-dimensional offset from the connection (line) along the length thereof, in accordance with the shape of the body part. Thus, a set of paired curves extending between respective pairs of points corresponding to skeleton joints are identified in the image, each pair of curves representing the shape of the respective body part of the body in the image.

FIG. 2A shows example pairs of curves 220a representing the outline shape of the clothing model's lower left leg. The (outline shape of the) lower left leg of the clothing model is represented by the pair of curves 220a. Curves 220a are positioned on respective inner and outer sides of the line (not shown) which directly links the point 210a that represents the left knee joint 210a and the left ankle joint 210a. As shown in Image B of FIG. 2A, the joint positions and shape of the curves may change as a result of warping, as described below. In this example, because the user's shape representation has indicated that the user has a larger body than that of the clothing model, image A has been warped to increase the clothing model's body size and hence the clothing model's left leg in image B has increased in size.

Accordingly, in some images, the first and second elements (joints and corresponding curves) may fully represent or describe the body shape in the image.

The third element comprises the self-occluded (non-visible) body parts. For example, in some images, the body in the image may be in a pose, in which one or more body parts are occluded by other body parts (e.g. the left forearm is in front of/behind the torso). If occluded body parts are identified, any associated joints and curve parameters (first and second elements) are not well defined, and cannot contribute to the representation of the body geometry within the image. In FIG. 2A, the inner curve of the clothing model's left upper arm is occluded by the torso in the pose.

Significantly, the curves of the image body geometry identify the outline shape of the body of a person, including the positions of respective body parts, in an image. For fitted clothing, the outline shape of a body part may be substantially aligned with the outline shape of the clothing. However, for loose clothing or items of clothing that do not follow body contours, the outline shape of a body part may be beneath the clothing. In either case, the application of a smooth image warping, meaning one where the change in displacement between adjacent pixels is small, that changes the shape and position of the curves simultaneously changes both the body shape and the item of clothing.

Processing techniques for determining the image body geometry comprising the three elements discussed above are known in the art of computer vision. The identification of the points/curves which comprise each element may be semi-automated (e.g. involving the use of manual editing to correct mistakes) or may be fully automated.

As the skilled person will appreciate, the image body geometry is associated with a particular image, and thus represents the outline body shape in the specific pose or body position shown in the image.

Clothing Model Image Pre-Processing

In accordance with some implementations of the present disclosure, each clothing model image is pre-processed as a pre-requisite to digital image manipulation.

In particular, for each clothing model image, an image body geometry of the body in the image (e.g. the body of the clothing model) is determined, using available methods to produce the points and curves in the manner described above. Furthermore, in some implementations, the head and hair of the clothing model are removed from the clothing model image prior to image transformation for the purpose of head replacement, as described below.

To remove the head and hair from the clothing model, firstly, standard skin, hair and feature point detectors may be run. Combining the hair and the skin in the region of the head (assisted by the feature points, which indicate where in the image the face is) gives a mask for which pixels are to be removed. The mask doesn't have to be precise: removing too many pixels causes little harm, while leaving some of the original face behind is damaging, so the mask may be expanded to err on the side of removing too much rather than too little. The masked area is then filled in with a standard hole filling algorithm. The person skilled in the art of image manipulation will be aware of such techniques.

The above pre-processing may use techniques known in the art of computer vision. Such techniques may be semi-automated (e.g. involving the use of manual editing to correct mistakes) or may be fully automated. Since the pre-processing of each clothing model image needs to occur only once, the use of manual editing may not be unduly time-consuming or expensive.

In addition, the pre-processing of a clothing model image may comprise dividing the model's body into sections. Each section is a portion of the model's body that is permitted to move across another portion of the model's body when the image is warped. Therefore, each section of the image is associated with a layer of the image. As one example, the model's body in FIG. 2a is divided into a plurality of sections, including sections corresponding to: the left arm, the right arm, the left leg, the right leg, the torso, and the skirt.

For each section of the model's body, skeleton points and curves can be identified (as explained above).

The pre-processing of the clothing model image may further comprise modelling each of the sections using a mesh. As one example, each section is modelled using a triangular mesh. For example, each node in the triangular mesh is either a point located on the outline of the section, or a point within the outline of the section. The interior nodes may be defined, for example, by Conforming Delaunay triangulation, or any other suitable technique.

Each section includes information defining the layer of the image. In the example shown in FIG. 2a, a section relating to the model's left arm includes information relating to a higher-order layer than a section relating to the model's skirt. This is because, in the image, the model's left arm is positioned over the skirt. Likewise, a section relating to the model's left leg includes information relating to a lower-order layer than both the skirt section and the left arm section. Also, the torso section (i.e. between the model's shoulders and waist) includes information relating to a higher-order layer than the left arm section, because the upper left arm is occluded behind the torso (as noted above). For more complex geometries, it will be appreciated that additional sections may be defined (e.g. upper left arm, lower left arm).

Each section also includes information defining the sections to which it is attached, and the locations (e.g. node locations) at which it is attached to other sections. For example, the left arm section may include information specifying that it is attached to the torso at the shoulder joint. The information may further define the nodes at which the left arm section is attached to the torso. As one example, the left arm section mesh may include a node at the exterior edge (i.e. shoulder) of the arm, a node at the interior edge (i.e. armpit) and two nodes in between. The left arm section information may specify that each of these nodes is attached to the torso. Likewise, the torso section may also include these nodes, along with information specifying that these nodes are attached to the left arm section.

The pre-processing of the clothing model image by dividing it into body sections may be performed manually, as it is not computationally intensive. Alternatively, the division into body sections may be automated in order to speed up processing.

Pre-processing of clothing model images may be carried out prior to receiving an input from a user.

Body Warping of Selected Clothing Model Image

FIG. 2 is a flowchart showing a method 200 for digitally manipulating a clothing model image to geometrically transform or “warp” the body in the image according to a body shape model for a user, in accordance with implementations of the present disclosure. A warp defines a displacement or movement for each pixel in the image, permitting the changes of shapes in the image. As the skilled person will be aware, useful warps are often smooth, meaning the change in displacement between adjacent pixels is small. For example, the method may be performed in response to selection of a clothing model image for clothing visualisation by a user. The body shape model for the user may be pre-determined, for example using the method of FIG. 1, and retrieved from memory. The method 200 may be performed by the processor of a hand held mobile device and/or may be performed by a specific application on the user's device. Of course, the skilled person will appreciate that the method, as with any of the methods disclosed herein, may be performed by any suitable processor or combination of processors, for example one or combinations of a user's handheld device, a user's laptop or computer, and one or more servers.

Data inputs to the method 200 are provided at blocks 210A, 210B, 210C and 210D. In particular, the user's body shape model is provided at block 210A, a pre-processed clothing model image is provided at block 210B and an image body geometry for the clothing model image is provided at block 210C. In addition, in the illustrated implementation, an image of the user's head is provided in block 210D, although this may be omitted from other implementations. The input data may be retrieved from memory. In particular, as described above, a body shape model for the user may be predetermined and stored in memory (e.g. associated with a user account). In addition, as described above, a selected clothing model image may be pre-processed to derive a clothing model body representation and the pre-processed clothing model image (e.g. with the head and hair removed, and/or divided into meshed body sections) may be stored in memory. Finally, users may upload an image of themselves which contains their head (and face), for example they make be asked to take a so-called “selfie”, for use in clothing visualisation, which may be stored in memory (e.g. associated with a user account).

At blocks 215A and 215B, one or more data item(s) are received. For example, at block 215A, the processor receives the clothing model's image body geometry and the user's body shape representation. The data items may be received in response to a request made by the processor and may be received from data storage, for example from a central storage server or from local storage.

Block 220 receives the user's body shape representation and the clothing model image body geometry as data inputs, and creates target curves 220b for the transformed image. Creating, or determining, the target curves is performed based on the user's body shape representation. Additionally, creating or determining the target curves may also be performed based on the “pose” of the clothing model image body geometry, wherein pose is defined by the set of skeleton joint locations and the limb self-occlusions.

In particular, a set of pairs of target curves 220b are created relative to the connection between specific pairs of joint locations 210b. Thus, each pair of target curves represents the shape of a body part of the user with respect to the associated “bone”. The target body curves are estimated as a function of the user's body shape representation (representing the target body shape) and the clothing model image body geometry (representing the pose of the clothing model in the image).

In one instance of the disclosed invention, the geometry of the target curves are generated from a set of training data. The training data is obtained from a plurality of people. For each person, a plurality of body shape (geometry) data is stored acquired from photographs of that person in a set of different poses. In this instance, the user's body shape model is defined with respect to the training individuals, specifically selecting the nearest training individual or weighted set of individuals. In order to generate target curves, the image body geometry data of similar shaped people in similar poses and similar occlusions, as identified and gathered from the training images, is used. As someone skilled in the art is aware, there are many ways of learning associations between an input (body shape representation, and pose) and an output (image body geometry) from training data, including but not limited to linear and non-linear regression models.

Block 230 determines a warp. The determined warp may be described as the warp required to transform the clothing model image in order to generate, or output, a warped image representing the user wearing the item of clothing. The resulting output image will show the clothing model having a body shape which matches or more closely aligns with the user's body shape. The required warp is thus based on the body shape representation produced at block 120 of FIG. 1, which in turn is based on the data provided by the user and received at step 110 and step 140 of FIG. 1. In this way, the warp may be described as being determined based on user attribute data and the user's feedback.

In implementations, block 230 receives the target curves created in block 220 and the clothing model image body geometry stored at block 210C, and determines a warp to modify the clothing model image such that the warped clothing model image body geometry matches the target curves. The determined warp may include a series of translations defined at each node location for all defined and meshed sections. Those translations may be chosen so as to agree with the target curves, and so as to maintain the smoothness of the resulting image by moving the pixels in a locally smooth fashion. Constraints involved in determining the warp may include agreement with the target curves, maintaining local image smoothness, and minimising bone bending.

Where body sections are defined and meshed, block 230 may include defining a warp for the sections in each layer of the image. For example, if a model in a clothing model image is standing partly side-on, so that one arm is partially occluded by the torso, then the layer information for the arm section will specify a lower-order layer than the layer information for the torso. A warp may be determined for the torso section substantially independent of the warp for the arm section (except for the constraint that the arm and torso are attached at the shoulder). For example, where the user has a larger body size than the model, the warp of the torso section may include target curves that occlude a greater proportion of the arm section than in the clothing model image. Modelling the body using sections in distinct layers therefore allows a warp to be applied that results in body parts moving over one another, thereby resulting in a more realistic warped image (by avoiding pixel compression at the interface between arm and torso, for example).

For some images, when determining the warp, it may be necessary to adjust the pose of the body in the clothing model image to ensure that the result is realistic. For example, if the torso gets thinner, then the arm bones should be pulled closer to the torso to avoid unrealistic stretching. In one implementation, such adjustments may be predicted based on the clothing model image body geometry and the user's body shape representation, and the predictions may be used in determining the warp. In another implementation the warp and/or the joint locations are adjusted to minimise a measure of distortion caused by the warp, including but not limited to the smoothness of the warp field.

At block 215b, the clothing model image is received by the processor. The clothing model image shows a clothing model wearing an item of clothing. The clothing model has a first body shape. While reference is made to a clothing model, the person depicted in the image may be any type of person; the term ‘first person’ is used elsewhere herein. The clothing model image may have undergone pre-processing, as described elsewhere herein. Block 240 creates the warped (transformed) clothing model image by warping the clothing model image in accordance with the warp determined at block 230. In other words, the processor transforms the first image in accordance with the determined image warp to generate a warped first image representing the user wearing the item of clothing.

In some implementations, the warped image obtained in block 240 may be corrected for artefacts, as described below, and output to the user for clothing visualisation. In some implementations, there is also a head replacement or head composite process, and a skin tone matching process, however these steps are both optional.

In the illustrated implementation, blocks 250 and 260 perform additional processing steps to further tailor the image presented to the user. In particular, the pre-processed clothing model image input at block 210B may be further processed to match the skin tone of the user, prior to warping in block 240. In addition, the user's head is added to the warped image from block 240, using head placement and image compositing, as described in detail below. As someone skilled in the art will realise, the order in which the head is replaced, the skin tone altered and the shape warped is not of critical importance.

In the illustrated implementation, block 260 receives the pre-processed clothing model image from block 210B and the user's head image from block 210D, and automatically determines and copies the skin tone from the user's head image to the clothing model image. In other implementations, block 260 may determine the user's skin tone from memory, for example a stored skin tone that formed part of the attribute data received at block 110 of FIG. 1. In an example, the user's skin tone may be manually selected by the user input using a graphical user interface when setting up an account as described above. Block 260 then passes the resulting clothing model image to block 240 to create the warped image with the user's skin tone.

Block 250 receives the warped image (optionally modified with the user's skin tone) and the user's head image from block 210D and composites the head of the user onto the clothing model image. In particular, block 250 determines a head image for the user according to a matching head placement. The head image is determined from the user's head image transformed (e.g. by translation and scaling) to look like a realistic placement of the head on the warped clothing image. An example of this process is described below. Thus, block 250 scales and positions the user's head image (with the required head placement) onto the body in the warped image (i.e. composites the head image onto the body in the warped image).

In some implementations, the warped image having the user's head obtained in block 250 may be corrected for artefacts, as described below, prior to block 270. Block 270 provides the artefact-corrected image as an output image to the user for clothing visualisation.

Image Processing to Correct Artefacts

As the skilled person will appreciate, the digital manipulation of a clothing model image using the method 200 of FIG. 2 involves a number of different computer graphics techniques and effects. For example, warping of the clothing model image in block 240 typically involves stretching, compressing and/or translating pixels, which may distort the image. Inserting a new head onto the pre-processed clothing model image in block 250 may lead to misalignment of pixels. Such misalignment may be exacerbated if the original pre-processing of the clothing model image included pixel errors in the removal of the original head. Furthermore, a reduction in head size (including the hair) may lead to unfilled background if the head is not removed in pre-processing. Accordingly, automated image processing techniques may be used to detect and correct these artefacts using one or more of the techniques described below.

Unrealistic pixel artefacts (erroneous pixels or pixel groups) are detected. As described above, such artefacts may be the result of (i) substantial warping in some areas, leading to non-smooth warp field or large compression/expansion of pixels, and (ii) errors in the removal and insertion of the head. Thus, a machine learning system may be used to identify these artefacts by analysing the warp field estimated in block 230 and/or the warped image output in block 270. Second, the detected unrealistic pixel artefacts may be corrected. A machine learning image inpainting system may be used to automatically replace problematic pixels (individual pixels or groups of pixels) with more realistic ones that fit in with the rest of the warped image.

Known in-painting techniques will be known to the skilled person. In a novel technique according to the present disclosure, in one implementation, the inpainting system is trained in a generative adversarial network (GAN) framework, with a discriminator to distinguish between synthesised and real images or image patches and an inpainting system (referred to in the art as a generator) that is co-trained to fool the discriminator. Optionally, the inpainting system can be trained concurrently with the artefact detection or it can be trained separately with the task being to fill in missing areas from real images, where missing areas are randomly generated. Optionally, the inpainting system may also take as input the determined/generated warp from block 230 and/or some representation of the warped clothing model image body geometry.

Thus, artefact detection and correction are used to ensure that the resulting images are realistic, by correcting pixels that have an unrealistic appearance or texture, due to pixel stretching, compression and the like resulting from the image transformation (warping). For example, a pixel that has been unduly stretched may be replaced by multiple pixels, each having a texture matching the surrounding pixels, using inpainting techniques.

Machine learning techniques based on training data obtained during system testing or otherwise may be used to improve on conventional machine learning image inpainting techniques, by providing the warped image body geometry as an additional input. As the geometry can be rendered from its ‘vector’ format, it will not suffer the artefacts you get from warping a finite resolution image.

Following the above described pixel artefact detection and correction, an overall failure detection mechanism may be implemented, prior to output of the final image to the user in block 270 of the method 200 of FIG. 2. For example, the complete image may be analysed to ensure that the final image is realistic.

Head Image Processing, Head Placement and Compositing

In order to provide a realistic image of what a user would look like wearing an item of clothing, it is desirable to superimpose or “composite” an image of the user's head onto the body in the image. There are a number of challenges in doing this when implementing the approach disclosed herein, in which the body in a clothing model image is digitally manipulated (warped) to the user's body shape.

In particular, the heads of different individuals vary in size and proportion relative to the rest of the body. In addition, the relative size of a head on a body provides a strong visual clue as to the height of the person, especially for clothing model images which often lack visual indicators of scale because the image is captured against a blank background. Accordingly, when superimposing an image of the user's head onto a body in a warped clothing model image, it is important that the scale (overall size) of the head is consistent with the user's height and head size so that the resulting image looks realistic and retains identity.

At least some of these challenges can be avoided by so-called “face swapping”. In “face swapping”, only the interior features of the face in the original image are swapped with those of the user; the face shape, head and hair of the clothing model in the original image remains the same. This maintains the pose of the head relative to the shoulders of the body. However, simply replacing the internal face features in the image without changing the face shape, head and hair does not provide a realistic impression of the user's appearance. In addition, the user's face is likely to be distorted to fit with the existing face shape and head orientation.

However, the use of “face swapping” or other approaches that maintain the original scale (overall size) of the head in the image does not provide an image with the correct head scale, as discussed above.

In accordance with the present disclosure, the body in the original image is warped, but the change of height is removed to reduce the amount of distortion required. In other words, and in contrast to prior methods, the clothing model image is not stretched or compressed, or otherwise warped or distorted, according to the user's height. Instead, the change of height is combined with the change of head size (by multiplying the two scale factors together).

Implementations disclosed herein provide a new approach involving replacing the head in the (original) clothing model image (herein called “head swapping”), which is implemented in block 250 of the method 200 of FIG. 2 as described above. In implementations of the present disclosure, the scale of the user's head when composited on the clothing model's body is based on the user's attribute data. In this instance, the attribute data provides an indication of height. This attribute data determines the degree to which the scale of the user's head is increased or decreased at block 250, i.e. when compositing the user's head on the clothing model's body. The head image of a tall user may be decreased in size during the composition process, whereas the head image of a shorter user may be increased in size during the composition process. Thus, the warp determined at block 230 may be determined without factoring in the user's height, which would otherwise be a difficult task if a realistic output image is desired. The user's height is then accounted for later in the process, e.g. at block 250, at which an output image is produced which is a realistic warped image representing the user wearing the item of clothing. The user recognises that their height has been accounted for due to the change in head size. This technique works, in part, because head size is a key factor when the human brain attempts to assess the height of a person based on a 2d image.

In “head swapping”, the user provides a head image that meets certain predefined conditions, based on application requirements. For example, when a user sets up an account for clothing visualisation, the user may be invited to capture at least one “head shot” image of themselves (e.g. a so-called “selfie”). The invitation may include instructions for head positioning (e.g. “front on” position). The image provided by the user may be stored in memory. The stored image may be retrieved in block 210D of the method 200 of FIG. 2 as described above.

The disclosed technique for head swapping involves pre-processing the selected clothing model image and the head shot image of the user. In particular, the clothing model image is pre-processed to remove the original head and hair of the clothing model, as in the pre-processed clothing model image provided in block 210B of the method 200 of FIG. 2. The user's head shot image is pre-processed by cutting out the user's head and hair from the image. Pre-processing may also involve detecting features points (face landmarks) as described below. This pre-processing may be performed in advance of clothing visualisation. Thus, pre-processed clothing model images and user head shots may be stored in memory for retrieval at the start of clothing visualisation.

The disclosed technique for head swapping further involves the placement and compositing of the user's head image on the clothing model image. Head placement refers to the positioning of the user's head in the user head image such that it appears to be positioned correctly with respect to the model's shoulders. Head placement is achieved by calculating an appropriate transform using modelling and/or machine learning techniques. Compositing refers to pasting or merging the image of the user's head with the correct head placement into the (warped) clothing model image.

Various approaches may be used for the head placement to derive a transformed head image of the user for compositing on the body in the clothing model image. In the following implementation, the head placement is based on identified feature points (face landmarks) in the user head image. Face landmarks are a predefined set of point locations in an image corresponding to precise identifiable points within the face features, such as the left corner of the left eye or the middle of the top of the upper lip. The head placement may additionally be based on other identified features in the image including one or more of: identified skin in the neck area, joint positions. Implementations may involve a combination of these techniques using modelling and/or machine learning based on training images.

Mathematical Modelling for Head Placement

A training dataset of head-shot images of different people in various head positions (head poses) are provided. In particular, training images may be obtained by asking participants to maintain their shoulders in a fixed position (e.g. by sitting with their back pressed against the back of a chair) and to capture head images at various positions (head poses) when turning their heads (i.e. facing different directions). Thus, each participant may capture a set of images taken in certain head poses such as “front on”, “facing left”, “facing right” and intermediate left-right positions; the head poses may also include head tilt.

Since each person has their shoulders fixed, all of the images in their set of images are lined up with respect to each other. However, the images from different participants are not lined up with respect to each other. Thus, the training images from all the participants are processed for alignment, for example by determining an average of all of the alignments found using the subsequently described technique. As an average over lots of poses is used, it should be more robust than a single alignment. Such alignment should produce training data of the participants' shoulders in substantially the same place and to substantially the same scale.

Following alignment of the training images, it should be theoretically possible to swap the heads between images of different participants in the same head pose whilst looking realistic. Accordingly, the training images can be used to understand how the head and neck, face, internal facial features and so on appear when moving between different head poses.

Accordingly, by analysing the aligned training images, a mathematical/machine learning model can be built and trained to learn how the head and neck move relative to the shoulders, and so how the neck and head, face and internal facial features appear in images in different head poses. Thus, it is possible to determine the required image transform (position and scale) for “head swapping”.

Thus, a machine learning/mathematical model can learn a mapping of, or predict, the transforms for changing the head and neck positions of a user head image between different head poses, taking into account translation and scale. This mapping can be used for head placement, comprising transforming a head image of the user (e.g. “front on” head-shot image) to fit with a clothing model pose in a clothing model image (e.g. “left facing” head pose).

Alternative Method for Determining Head Placement

An alternative method to that described in the preceding section is now described. This method involves the use of a large training dataset of full-body images, which are used by a machine learning/mathematical model to determine head placement.

The full-body images in the training dataset are considered to comprise two parts: the head, and the rest of the body. For each part of each image, computer vision techniques are used to estimate two-dimensional landmark points on that part. For example, for the head, computer vision techniques are used to identify landmark points around the eyes, eyebrows, nose, mouth and jawline. For the body, computer vision techniques are used to identify landmark points that correspond to the skeleton points (i.e. points 210a in FIG. 2a). In one example, landmark points for the two parts are identified for all images in the training dataset.

For each of the two parts of each image (i.e. head and body) in the training dataset, an AI system (also referred to herein as a machine learning/mathematical model) is trained to predict a coordinate system for the part of the image. That is, the AI system is trained to predict a first coordinate system from the landmark points identified on the head, and a second coordinate system from the landmark points identified on the body. Each of the first and second coordinate systems comprises an origin (e.g. an (x,y) location in the image) and a scale factor (e.g. a number of pixels in the image that one unit of the coordinate system corresponds to).

The AI system is trained to simultaneously estimate both the first and second coordinate systems as a function of the landmark points in order to minimise the difference between the first coordinate system (i.e. for the head) and the second coordinate system (i.e. for the body), for each training example (i.e. each image). When the difference between the coordinate systems is minimised, a consistent coordinate system can be used to describe the locations of the landmark points on both the head part of the image and the body part of the image. Minimising the difference between the coordinate systems may be achieved by e.g. stochastic gradient descent.

This means that, once the difference between the first and second coordinate systems is minimised, a consistent coordinate system can be used to determine, from the head part of the image, where the body is located. Likewise, the consistent coordinate system can be used to determine, from the body part of the image, where the head is located. Consequently, although there is no ground truth location for the coordinate system, minimisation of the difference between the coordinate systems (so that, for example, the coordinate systems match) provides a consistent placement for the head that is irrespective of the morphology of the face and the rotation of the head in 3D.

The training dataset may include images with a variety of different head positions, so that the AI system is trained to predict coordinate systems for heads irrespective of the direction in which the head is facing.

The result of the training process is an AI system that can take, as input, a set of landmark points (either on the head or the body), and output a consistent coordinate system that can describe the locations of landmark points on both the head and the body. The AI system is therefore trained to determine two functions for outputting consistent (i.e. head and body) coordinate systems, based on respective vectors of landmark points (i.e. head landmark points and body landmark points, respectively) input to it. The model is trained offline, and only the head co-ordinate system estimator is needed when replacing heads. That is, the AI system is used with landmark points for the head.

The outcome of learning a consistent coordinate system is that both systems effectively learn a consistent placement of the neck starting from either the head or the body.

The skilled person will appreciate that for the training process, full-body images are not necessarily required. For example, the training process may be carried out using a dataset of upper-body images (e.g. with the legs omitted).

The trained AI system is then used to output a consistent coordinate system given feature points on the model head as input. This process can be carried out offline (i.e. prior to user input), as part of the pre-processing of the clothing model image at 2108 in FIG. 2. That is, the feature points on the head of the model image can be identified, and input to the trained AI system. The output from the trained AI system is a coordinate system for the model image head that includes an origin and scale factor (as explained above).

Once the user has input an image of their head, feature points on the head of the user's image can be identified. The feature points on the user's head can then be input to the trained AI system, which outputs a coordinate system for the user's head.

The coordinate systems for the model image head and for the user's head can then be used to position the image of the user's head on the body of the clothing model. This is done by using a transform between the two coordinate systems to position the user's head on the body of the clothing model by scaling and translating the image of the user's head. As the AI system is trained to output a coordinate system that consistently describes landmark points on the head and body, the user's head will be correctly positioned with respect to the body of the clothing model (i.e. at the neck).

After the coordinate systems have been used to position the user's head image on the body of the model image, the user's head image may be scaled to account for the height of the user, as described above.

The skilled person will appreciate that full-body images are not necessarily required in the above method after the mapping is learnt. Because the head co-ordinate system is consistent with respect to any biologically possible body configuration, a first head can be used to correctly predict the placement of a replacement head.

Head Placement and Compositing on Clothing Model Image

FIG. 3 is a flowchart showing a method 300 for head placement and compositing on a clothing model image in accordance with implementations. For example, the method 300 may be performed as part of step 250 of the method 200 of FIG. 2. In summary, instead of simply matching the user's head to the clothing model's head, as done in some prior methods, the present disclosure involves positioning the user's head image on the clothing model's neck in a manner which is plausible given the position of the model's shoulders in the image.

Data inputs to the method 300 are provided in blocks 210D and received from step 240 of the flowchart of FIG. 2. 210D is the user-uploaded image of their own head, at an angle which their face is visible. At blocks 320A and 320B the user's head image and the warped clothing model image are processed. In particular, block 320A extracts the user's head and hair from the head-shot image to obtain a user head isolation image (i.e. a head-only image with the background and any other body parts removed). Block 320B cuts out the clothing model's head and hair from the warped clothing model image. This step may be performed as part of step 250, or may form part of the clothing model Image pre-processing steps described above. The resulting clothing model image, in which the model's head and hair have been removed, may form the pre-processed model image. More generally, and as indicated above, the processing in blocks 320A and 320B may be performed in advance of clothing visualisation. In that case, pre-processed images may be retrieved from memory in and blocks 320A and 320B may be omitted.

Replacing heads in a naive way can result in the head appearing to be the wrong scale, or the neck joining the shoulders in an unnatural position.

Block 330 identifies a set of feature points (face landmarks) in the respective user head image (having a user, or first, head pose) and clothing model head image (having a model, or second, head pose). In other words, the features which together comprise the model's face, and the features which together comprise the user's face, are identified. The feature points identified in the user head image may be referred to as the user's feature points and the feature points identified in the clothing model head image may be referred to as the model's feature points. Block 330 may also be performed in advance and the identified feature points may be stored in memory as data associated with the respective pre-processed image.

Block 340 estimates the transforms required. A first transform for the user's head image is generated/estimated based on the user's feature points. A second transform for the model's head image is generated/estimated based on the model's feature points. Block 340 may estimate the image transforms using modelling and/or machine learning techniques based on training data as described above or alternatively by using the process derived from minimising the difference between (or matching) a first (head only) coordinate system and a second (rest of body) coordinate system. As the skilled person will appreciate, the basic estimated transforms correspond to a translation and scaling of the user's head isolation image to minimise the distances between the user's and model's feature points. However, this will result in a bad head placement, i.e. a placement that does not result in a realistic output image. Consider a user's head looking left and a model's head looking right; in this scenario simply matching the internal features of the faces in a naive manner will mean the necks are in different places. By using the training data (using either of the methods described above), it is possible to build a model that has knowledge of how the feature points should be used to predict the neck position from any head pose, so that the visual appearance of the result is optimal.

Block 340 may be implemented using any suitable modelling and/or machine learning technique based on suitable training data. In one implementation, the user's head image may be transformed into the space of training data and back out into the space of the clothing model's head. A weighted sum of transforms derived from the training images may be calculated (with higher weights for heads in the training images that are looking in the same direction and low or zero weights for bad matches) to determine an estimated transform. The transforms minimize distances between model and target feature points, but because only similar poses are considered, it is now a valid thing to do. Additionally averaging over several transforms adds robustness. In one implementation, facial orientation and face shapes are matched by first aligning the points of the face based solely on the exterior points (e.g. around the jawline), then comparing the interior points. Faces oriented in different directions will contain interior points in different locations.

Implementations of step 340 may use other techniques to determine the relative head positions (head poses) of the user head image and the clothing model head image, and the translation and/or scale of the user head image in estimating the transform. For example, one technique may utilise a “skin mask” and consider the skin in the neck area of the user head image. In particular, a skin mask of the image may be produced/calculated, and the area where the neck is expected to be may be estimated using the feature points of the face. The horizontal centre of the skin mask in the neck area may be calculated and used for determining the translation in the x direction of the transform. As standard skin segmentation algorithms do not distinguish between skin on the head and on the neck, pixels of the skin mask may be weighted using heuristics to consider only samples on the neck. Such heuristics can include: how narrow horizontally the skin area is for a given horizontal slice, as the neck is narrower than the shoulders or head. Also the approximate position of the neck may be estimated from the position of the head. Another technique may utilise the joint positions of the shoulders as the result of a standard body finding system. In particular, the position of the shoulders may be calculated, and the scale taken from the distance between the shoulders. The position of the base of the neck may be determined from the average of the shoulder joint positions, and the translation between source and target from the relative difference in positions.

Because the transforms in Block 340 transforms both user's and model's heads into the canonical coordinates of the training set, they must be combined to calculate the transform of user's head to the model head's coordinates. Block 350 combines the transform from the user's coordinates into training coordinates followed by an inverse transform from training coordinates back to the model's coordinates to produce the resulting transform from the user's coordinates into the model's coordinates. The combined estimated transform for the head image aims to reposition the head of the user to a plausible location in the clothing model image.

Block 360 creates a transformed user head image with the appropriate head placement based on the combined transform produced at block 340. This can be described as creating a transformed head image of the user based on the estimated/combined transform from block 350, for compositing into the warped first image. In particular, the user head image may be translated and resized according to the estimated transform. Block 370 composites (i.e. pastes or merges) the transformed user head image onto the (warped) body in the pre-processed clothing model image (i.e. with the clothing model head removed from block 320B). Block 370 may use any suitable technique for compositing the transformed user head image and the clothing model image. Following block 370, the composite image may be corrected for artefacts as described below.

Optionally, block 380 refines the resulting composite image. The process may involve two distinct feedback loops. The first involves asking the user to evaluate the result. Based on this evaluation, the ‘first’ transform, i.e. the transform estimated based on the user's feature points, is adjusted based on the user feedback. The second feedback loop can be trained based on data. In particular, a suitable technique may be used to detect how realistic the resulting image appears. For example, block 30 may implement a system known as Spatial Transformer Generative Adversarial Network (ST-GAN) for image compositing, for providing feedback to refine the image transformation. This approach modifies the head placement transform to maximise the realism of the composite image, by training a discriminator that can distinguish between head replacement composite and real images and training a transformation refiner model or generator to “fool” the discriminator.

Thus, block 380 may determine and provide a refinement of the estimated transform as feedback to block 340. The method then continues by repeating the process of estimating a transform at block 340, combining the transforms at block 350, creating a transformed user head image at block 360, compositing the head image and the clothing model image at block 370 and evaluating the result at block 370. The ST-GAN technique is improved upon in this application by receiving the initial estimated transformation as input and the height of the user to ensure a realistic head scale is found. Optionally, the discriminator trained for evaluating head placement can be used directly to find mistakes.

When the process at block 380 determines that the composite image is realistic in terms of head placement, overall scale, facial features and so on, the composite image is provided to block 270 of the method 200 of FIG. 2 and the image is outputted.

In some implementations, a combination of techniques based on feature points, skin mask, joint positions and so on may be used to estimate the image transform. Where multiple techniques are used, the estimated transform may be determined as an average or something more sophisticated, of the transforms estimated by the multiple techniques.

Artefact Correction for Head Placement

Implementations of step 360 may use any suitable technique for compositing one image with another, for example based on an Alpha mask. Typically, the techniques assume that the Alpha mask and unmixed colours are perfect. However, this is often not the case when compositing a user head image into a clothing model image as in the present disclosure. Estimating the correct alpha masks and mixing colours accurately is challenging. With imperfect inputs, the output will have artefacts around the edges of the overlaid head.

Accordingly, such artefacts need to be detected and corrected, for example by inpainting or other automatic image editing techniques. The regions in which artefacts are likely to occur may be learned to improve such techniques, as described above.

Correction of artefacts may take place at any suitable point in the process, as would be understood by the skilled person.

Advantages

The new approach proposed in the present disclosure has a number of advantages.

In particular, the approach requires clothing model images of only one clothing model wearing each item of clothing. It is not necessary to model each item of clothing in 3D. In particular, since the approach maintains the body pose of the clothing model in the original image in the resulting (warped) image, clothing simulation is not required. Any pose repositioning is minor to address unrealistic positioning of body parts for the transformed body shape. All that is required from the user's perspective is a limited amount of input, for example simply the attribute data, which may be provided in a quick and easy manner via sliders on a GUI, and a photograph containing their head at an angle such that their face can be seen. Based on this user information a clothing visualisation can be created using any clothing model image. Due to working on existing images, the technique can be quickly applied to a seller's existing catalogue without needing physical access to their clothes. Also, there is minimal intrusion for the user. They only need to provide a photo of their face, rather than be subjected to a full body scan.

Accordingly, the approach involves fast and efficient image processing techniques, which can be implemented by a web server in real time, for example whilst a user is browsing a website of an online clothing retailer.

Other Implementations

It will be understood that the above description concerns specific implementations, by way of example only, and is not intended to limit the scope of the present disclosure. Many modifications of the described implementations are envisaged and intended to be within the scope of the present disclosure.

Some examples of modifications are now described.

Adjustment of Image for Clothing Fit

A further implementation of the disclosed method additionally adjusts the position of the visible edges of the item of clothing relative to the body in the image, to accurately show how they would appear on the user's body.

For instance, if a user is taller than the clothing model shown in the clothing model image but has a similar clothing size, then the length of a dress, skirt or trousers should appear shorter (the hem line is higher up the legs) on the user's body in the transformed image than on the clothing model in the clothing model image. Likewise, if the user is a similar height to the clothing model shown in the original image but has a larger clothing size, then the length of the dress, skirt or trousers should appear longer (the hem line is lower down the legs) on the user's body in the transformed image, since such items of clothing typically have a longer length for a larger clothing size (and vice versa). Similar variations in the position of garment edges arise with varying body heights and shapes in relation to other aspects of clothing length, such as the length of a top in relation to the torso, the length of the sleeves in relation to the arm, the shape and position of the neck line in relation to the upper chest and so on.

A method of digitally manipulating (warping) a clothing model image according to the above described implementations is not always able to adjust the positioning of edges of clothing, such as hem lines, sleeve lines and neck lines to provide a realistic impression of how the clothing edges would appear on the user. Accordingly, the following implementations perform additional image manipulation for this purpose. For example, additional image processing may be performed as part of step 240 of the method 200 of FIG. 2.

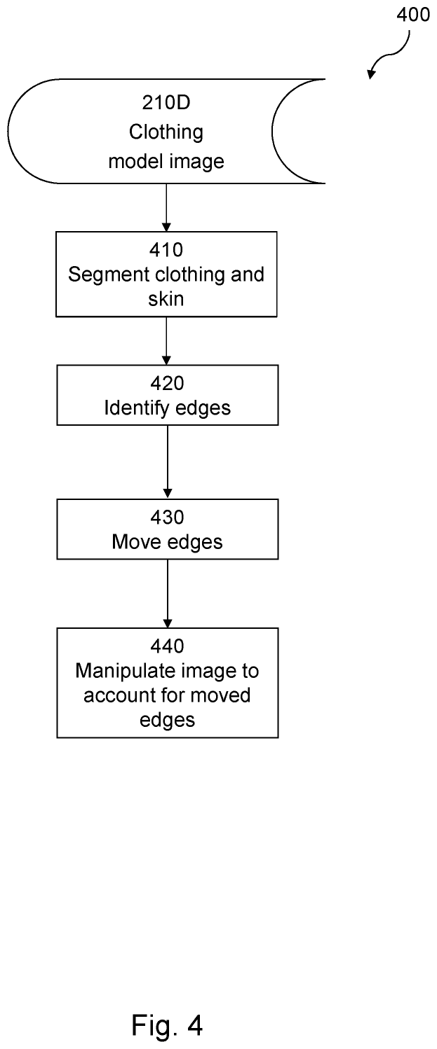

FIG. 4 is a flowchart of a method 400 for adjusting the position of clothing edges on a clothing model image, in accordance with implementations.

The clothing model image is provided as a data input to the method 400. For example, the clothing model image is stored at block 210B of the method 200 of FIG. 2. The set of steps depicted in FIG. 4 may be comprised within and/or interleaved with the processes at blocks 230 and 240 of the flowchart of FIG. 2. The warp determined in 230 will be modified by these steps. The warp will happen once, and hole filling will happen in the same module any other artefact correction.

At block 410, the skin and clothing of the model is segmented. In other words, regions of the image which show the model's skin and regions of the image which show the model's clothing are identified. Skin and clothing segmentation can be performed with standard image segmentation techniques.

At block 420, having identified regions of the image which contain the model's skin and regions of the image which contain the model's clothing, the edges of these regions are identified. The clothing and skin edges are automatically derived from the segmentation of the body into skin and clothing areas.

Block 430 moves the identified edges. The edge movement may be performed based on the user's height and/or clothing size, obtained via the attribute data received at step 110 of FIG. 1, and based on the model's height and/or clothing size which may be inferred from the model's image or stored in memory. In particular, the edge movement may be performed based on a determined difference in measurement and/or clothing sizes between the clothing model and the user. Modelling and/or machine learning techniques can be used to predict the change in length of an item of clothing based on the measurement differences and optionally using data associated with the item of clothing for different clothing sizes. Thus, for example, if the clothing model is taller than the user but has a similar clothing size, the hem line (e.g. for a dress, skirt or trousers) should appear lower down the legs of the user by an amount that can be calculated based on the measurement differences.

The movement of the clothing edges can be carried out using a warp. Because the warp is carried out along the direction of a limb, and because there are joints along limbs that should not be moved, warps that cause large stretching or squashing are sometimes necessary to perform the required amount of displacement. Large squashing or stretching results in visibly distorted output. Areas of a warp field that stretch or squash can be easily identified as is obvious to someone skilled in the art. These areas are then identified for replacement with a natural looking patch. Block 440 replaces unnatural areas. The replacement can be carried out using a standard hole filling technique.

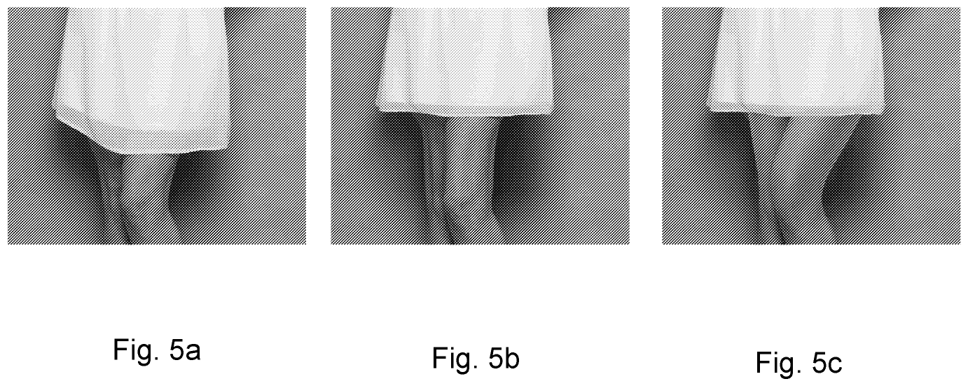

FIGS. 5 a-c shows a case of moving a hemline upwards using warping, as an example. The original image is shown in FIG. 5a. Because the knee should remain fixed in place, the area between the knee and the hemline is stretched unnaturally as shown in FIG. 5b. FIG. 5c shows the unnatural area replaced with realistic looking legs using a hole filling technique on the stretched area.

Other variations and modifications of the described implementations will be apparent to the skilled person.

Disclosed herein is a computer-implemented method for transforming a first image, the first image showing a first person wearing an item of clothing, the first person having a first physical body shape. The method comprises receiving attribute data from a user indicative of the user's physical body shape. The attribute data may include, for example, measurements of or indications about the user's body shape. The method comprises producing a body shape representation for the user based on the attribute data. The body shape representation for a user may be a mathematical abstraction or representation of the physical body shape of the user. The method may further comprise receiving the first image. The first image may depict a model or clothing model wearing the item of clothing, and therefore may be called a clothing model image. The method further comprises determining, based on the determined body shape representation, an image warp for warping the first image such that the first person is depicted as having the user's body shape, and then transforming the first image in accordance with the determined image warp to generate a warped first image representing the user wearing the item of clothing.

Accordingly, the method generates a digitally manipulated (transformed or warped) image, which in some implementations is a clothing model image. The warped image allows a user to visualise themselves wearing the item of clothing. The digitally manipulated clothing model image shows the item of clothing on the second person with the second physical body shape. Thus, only a single clothing model image of a clothing model wearing each item of clothing is needed for clothing visualisation. The clothing model image showing the clothing model can be digitally manipulated to show a plurality of different people wearing the particular item of clothing based on body shape representations representing their respective physical body shapes.

There is also provided a method for determining a body shape representation for a person. The method receives the user measurements, the measurements relating to the physical body shape for the person. The method estimates a body shape representation for the person based on the user measurements. The body shape representation estimate may be determined using one or more of a mapping of user measurements to one or more training images, and a machine learning/mathematical model for predicting body shape. The method provides an image representation of the estimated body shape representation to the user. The method adjusts the body shape representation based on feedback from the user.

Accordingly, an image body geometry for a person, which represents the body shape and pose of the person in the clothing model image is generated. The body shape model is individually tailored to the user based on a set of specific body measurements and user feedback. Thus, an accurate representation of the body shape model is used for clothing visualisation.

Accordingly, an image is generated using the user's body shape representation by manipulating a clothing model image. The image retains the original pose of the clothing model, but is warped using the user's body shape representation. The body shape model is individually tailored to the user using their specific body measurements and based on user feedback. Thus, an accurate representation of the body shape model is used for clothing visualisation.

As the skilled person will appreciate, the order of blocks illustrated in the flowcharts herein are by way of example only. The processing performed in the various blocks may be carried out in any suitable order, including concurrently.

The techniques disclosed herein may be embodied on a computer-readable medium, which may be a non-transitory computer readable medium. The computer-readable medium may comprise the computer readable instructions for execution by a processor to carry out one or more of the steps of the methods described herein.

The term “computer readable medium” refers to any medium that stores data and/or instructions for causing a processor to operate in a specific manner. Such storage medium may comprise non-volatile media and/or volatile media. Non-volatile media may include, for example, optical or magnetic discs. Volatile memory media may include dynamic memory. Exemplary forms of storage medium includes a floppy disk, flexible disk, a hard disk, a solid state drive, a magnetic tape or any other magnetic data storage medium, a CD-ROM, any other optical data storage medium, any physical medium with one or more patterns of holes, a RAM, a prom, and EEPROM, FLASH EPROM, NVRAM and any other memory chip or cartridge.

1. A computer-implemented method for transforming a first image, the first image showing a first person wearing an item of clothing, the first person having a first physical body shape, the method comprising:
receiving attribute data from a user indicative of the user's physical body shape;
producing a body shape representation for the user based on the attribute data;
receiving the first image;
determining, based on the determined body shape representation, an image warp for warping the first image such that the first person is depicted as having the user's body shape; and
transforming the first image in accordance with the determined image warp to generate a warped first image representing the user wearing the item of clothing.

2. A method as claimed in claim 1, further comprising:
determining a pose of the first person in the first image;
determining target curves based on the determined pose and based on the user's body shape representation; and
determining the warp based on the determined target curves.

3. The method of claim 2, wherein determining the pose of the first person comprises representing the first physical body shape as an image body geometry, the image body geometry comprising a set of points and curves, wherein each point represents the position of a skeleton joint, and each curve represents the position and shape of a respective body part relative to a bone between two skeleton joints represented by a pair of the points.

4. The method of claim 3, wherein determining the warp is further based on the curves of the image body geometry.

5. The method of claim 1, wherein the first image is divided into a plurality of sections, wherein a first section of the plurality of sections is associated with a first layer of the first image and a second section of the plurality of sections is associated with a second layer of the first image, the second layer being different to the first layer.

6. The method of claim 5, wherein transforming the first image in accordance with the determined image warp comprises transforming at least one of the plurality of sections.

7. The method of claim 6, wherein transforming at least one of the plurality of sections comprises transforming the first section such that a portion of the second section that was visible in the first image is occluded in the warped image.

8. The method of claim 1, further comprising:
changing the skin tone of the person shown in the first image to match the skin tone of the user.

9. The method of claim 8, wherein the skin tone of the second person is determined from an image of the user, a skin tone selected by a user or a combination thereof.

10. The method of claim 1, further comprising:
manipulating the warped first image to reposition one or more clothing edges of the item of clothing for consistency with the physical body shape of the user.

11. The method of claim 1, further comprising:
replacing the head and/or face of the first person in the first image with the head and/or face of the user based on a head image of the user provided by a user.

12. The method of claim 11, further comprising:
receiving the head image of the user;
determining feature points of the head of the user in the head image;
determining feature points of the head of the first person in the first image;
estimating a transform for the head image to reposition the head to a plausible location in the clothing model image; and
creating a transformed head image of the user based on the estimated transform, for compositing into the warped first image.

13. The method of claim 12, wherein the transform for the head image is determined using a mathematical/machine learning model of head positions, wherein the inputs to the model include:
the feature points of the head of the user in the head image, and
the feature points of the head of the first person in the first image.

14. The method of claim 13, wherein the mathematical/machine learning model is determined using a dataset of training images comprising a plurality of sets of training images, wherein each set of training images comprises a plurality of images of the head of the same person at different head positions relative to their shoulders.

15. The method of claim 14, wherein the shoulders are either held in a fixed position for each of the images or else the shoulders in each of the training images are aligned using a computer vision technique.

16. The method of claim 11, wherein the attribute data comprises the user's height, and the transformed head image is scaled based on the height of the user and the first person.

17. The method of claim 11, wherein replacing the head of the first person in the first image with the head of the user comprises:
removing the head of the first person from the first image; and compositing the head image of the user and the first image.

18. The method of claim 11, wherein replacing the head of the first person in the first image with the head of the user comprises:
computing, using a trained AI system, a first coordinate system based on feature points of the head of the user in the head image;
computing, using the trained AI system, a second coordinate system based on feature points of the head of the first person in the first image;
determining a transform between the first and second coordinate systems; and
using the transform to replace the head of the first person in the first image with the head of the user in the head image.

19. The method of claim 18, wherein the trained AI system is trained using a dataset of images, each image in the dataset comprising a head part and a non-head part, wherein for each image in the dataset, the trained AI system is trained to predict a coordinate system from feature points of the head part and a coordinate system from feature points of the non-head part such that the difference between the coordinate system predicted from the feature points of the head part and the coordinate system predicted from the feature points of the non-head part is minimised.

20. The method of claim 1, wherein the attribute data comprises measurements provided by a user.

21. The method of claim 20, wherein determining the body shape representation for the user comprises:
receiving the user measurements, the measurements relating to defined features of the user's body shape;
estimating a body shape representation for the user based on the user measurements using one or more of: a mapping of user measurements to one or more training images depicting people having a known physical body shape, and a machine learning/mathematical model for predicting body shape.

22. The method of claim 21, further comprising:
providing an image representation of the estimated body shape representation to the user; and
adjusting the body shape representation based on feedback from the user.

22. (canceled)

23. A method for determining a body shape representation for a user, comprising:
receiving measurements relating to the user's body shape from the user;
estimating a body shape representation for the user based on the user measurements, using one or more of:
a mapping of user measurements to a physical body shape;
a mapping of user measurements to one or more training images depicting people having a known physical body shape, or
a machine learning/mathematical model for predicting body shape;
providing an image representation of the estimated body shape representation to the user, and
adjusting the body shape representation based on feedback from the user.

24. A computer readable medium comprising instructions that, when executed by a processor, cause the processor to perform steps to transform a first image, the first image showing a first person wearing an item of clothing, the first person having a first physical body shape, the steps comprising:
receiving attribute data from a user indicative of the user's physical body shape;
producing a body shape representation for the user based on the attribute data;
receiving the first image;
determining, based on the determined body shape representation, an image warp for warping the first image such that the first person is depicted as having the user's body shape; and
transforming the first image in accordance with the determined image warp to generate a warped first image representing the user wearing the item of clothing.

25. A method as claimed in claim 21, wherein the mapping and/or machine learning/mathematical model for estimating the body shape model is determined from a dataset of training images of a people of a known body shape in a plurality of different body poses.
